(19) United States
(12) Patent Application Publication
(10) Pub. No.: US 2021/0049336 A1
(43) Pub. Date: Feb. 18, 2021

(54) RECOGNITION APPARATUS

(71) Applicant: SHANGHAI HARVEST INTELLIGENCE TECHNOLOGY CO., LTD., Shanghai (CN)

(72) Inventor: Hong-yih TSENG, Tainan (TW)

(73) Assignee: SHANGHAI HARVEST INTELLIGENCE TECHNOLOGY CO., LTD., Shanghai (CN)

(21) Appl. No.: 16/967,863

(22) PCT Filed: Jun. 1, 2018
(86) PCT No.: PCT/CN2018/089623

§ 371 Date: Aug. 6, 2020

(30) Foreign Application Priority Data
Feb. 9, 2018 (CN) 201810132613.9

(51) Int. Cl. G06K 9/00; G06F 3/042

(52) U.S. Cl. CPC G06K 9/0004; G06K 2009/0006; G06F 3/0428; G06K 9/00053

(57) ABSTRACT

A recognition apparatus includes a light-transmissible top plate, a bottom plate, a light emitting unit, a photoluminescent unit, and a sensor module. The light-transmissible top plate and the bottom plate cooperatively define an inner space. The light emitting unit and the photoluminescent unit are in the inner space. The photoluminescent unit includes a plurality of quantum dots able to be excited by an initial light to emit an excitation light. The excitation light travels for irradiation on an object and is reflected to generate a reflection light travelling along a second path. The sensor module is disposed on the second path to receive the reflection light and to recognize an image of the object.

### FIELD

The disclosure relates to a recognition apparatus, and more particularly to a recognition apparatus with a photoluminescent unit.

### BACKGROUND

Biometrics refers to personal identification or recognition based on metrics related to a person's biological features, such as fingerprint, face, etc. Compared with conventional recognition methods, such as asking the person to be identified to enter password or signal, biometrics has relatively high reliability in verifying identity. In the field of biometrics, fingerprint recognition is one of the widely-used recognition methods. The fingerprint recognition is classified into optical-type, capacitive-type, ultrasonic-type, etc. The optical-type fingerprint recognition is carried out based on the principle of light reflection and has a relatively low cost and a relatively good reliability.

Referring to FIG. 1, a conventional optical recognition device 1 is generally to be disposed in a portable electronic device 2 that includes a touch region 21 and a recognition region 22, such as a cell phone or a tablet. The touch region 21 is available to be touched by a user. The recognition region 22 is spaced apart from the touch region 21 by design, and is adapted to accommodate the conventional optical fingerprint recognition device 1. Thus, during reflection of visible light emitted from an inner portion of the conventional optical recognition device 1, the reflected visible light for performing the fingerprint recognition is not interfered by light emitted from the touch region 21 so as to avoid failure in fingerprint recognition. In order to reduce light interference of the touch region 21 with the conventional optical recognition device 1, and to further integrate the conventional optical recognition device 1 into the touch region 21 to perform the fingerprint recognition in the touch region 21, it is proposed to replace the light emitted from the inner portion of the optical recognition device 1 with infrared light. However, such replacement requires disposing of an additional light emitting diode (LED) that emits the infrared light in the portable electronic device 2, and energy consumption is thus increased. Furthermore, additional installation of the LED will increase the size of the portable electronic device 2 and the manufacturing cost thereof is increased, accordingly.

### SUMMARY

Therefore, an object of the disclosure is to provide a recognition apparatus that can alleviate at least one of the drawbacks of the prior art.

According to the disclosure, a recognition apparatus includes a light-transmissible top plate, a bottom plate, a light emitting unit, a photoluminescent unit, and a sensor module.

The light-transmissible top plate has a first surface facing an object to be recognized and a second surface opposite to the first surface.

The bottom plate is spaced apart from the light-transmissible top plate and faces the second surface of the light-transmissible top plate. The light-transmissible top plate and the bottom plate cooperatively define an inner space therebetween.

The light emitting unit is disposed in the inner space and is adapted to emit an initial light.

The photoluminescent unit is disposed in the inner space. The photoluminescent unit includes a plurality of quantum dots that is able to be excited by the initial light to emit an excitation light having a wavelength range different from that of the initial light. The excitation light travels along a first path to exit from the inner space through the light-transmissible top plate for irradiation on the object and is reflected from the object to generate a reflection light travelling along a second path to re-enter the inner space.

The sensor module is disposed in the inner space on the second path so as to receive the reflection light and to recognize an image of the object generated by the reflection light.

### BRIEF DESCRIPTION OF THE DRAWINGS

Other features and advantages of the disclosure will become apparent in the following detailed description of the embodiment with reference to the accompanying drawings, of which:

FIG. 1 is a schematic top view illustrating a conventional optical recognition device disposed in a portable electronic apparatus;

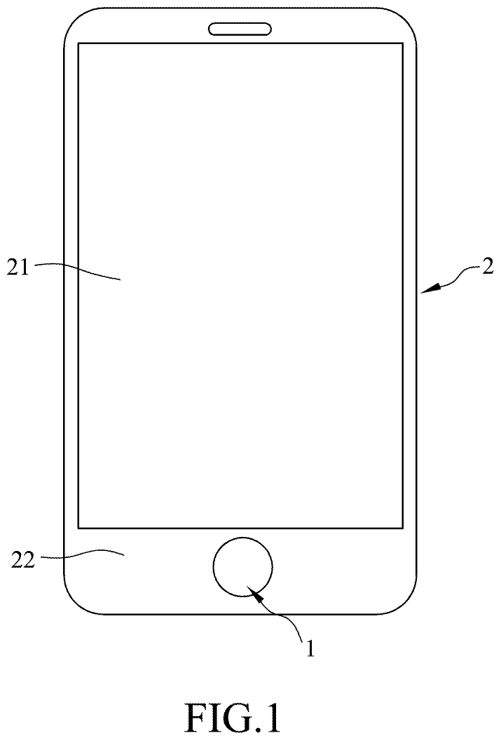

FIG. 2 is a fragmentarily schematic cross-sectional view illustrating an embodiment of a recognition apparatus according to the disclosure;

FIG. 3 is a schematic cross-sectional view illustrating quantum dots of a photoluminescent unit included in the embodiment;

FIG. 4 is a block diagram of a sensor module included in the embodiment;

FIG. 5 is a fragmentarily schematic cross-sectional view illustrating another configuration of the embodiment illustrated in FIG. 2; and

FIG. 6 is a fragmentarily schematic view illustrating application of the embodiment of FIG. 2 for face recognition of a human being.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

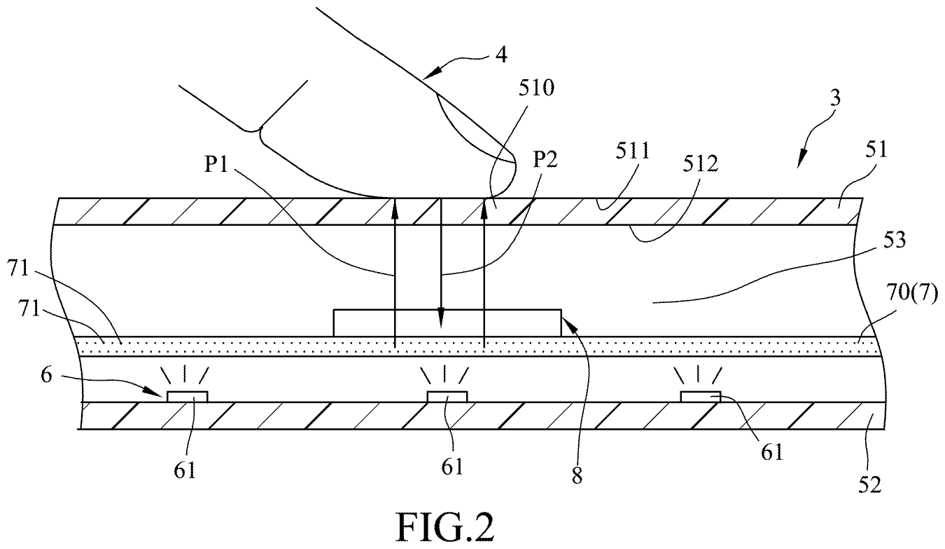

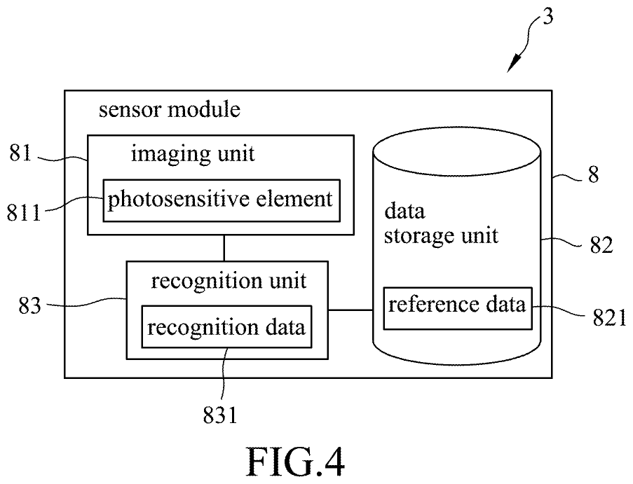

Referring to FIGS. 2 and 4, an embodiment of the recognition apparatus 3 according to the disclosure is adapted for recognizing an object 4 which may be a user's fingerprint or face. In the embodiment, the object 4 is exemplified to be the fingerprint. The recognition apparatus 3 includes a light-transmissible top plate 51, a bottom plate 52, a light emitting unit 6, a photoluminescent unit 7, and a sensor module 8.

The recognition apparatus 3 may be integrated into various electronic equipment requiring a touch screen or panel, which includes but not limited to a portable electronic device, e.g., a cell phone and a tablet, a liquid crystal display television (LCD TV), an automatic teller machine (ATM), or an access control machine. The light-transmissible top plate 51 is adapted to serve as the touch screen or panel of the electronic equipment for image display or touch operation.

In this embodiment, the light-transmissible top plate 51 has a first surface 511 facing the object 4 to be recognized and a second surface 512 opposite to the first surface 511. The bottom plate 52 is spaced apart from the light-transmissible top plate 51 and faces the second surface 512 of the light-transmissible top plate 51. The light-transmissible top plate 51 and the bottom plate 52 cooperatively define an inner space therebetween. Specifically, the light-transmissible top plate 51 may be integrated with other elements, such as a printed circuit board, a polarizer, a liquid crystal layer, and so forth. The elements adapted to be integrated with the light-transmissible top plate 51 are well known to those skilled in the art, further details thereof are not provided herein for the sake of brevity. In one form, the light-transmissible top plate 51 may be a glass plate without touch function, and the first surface 511 of the light-transmissible top plate 51 facing the object 4 is an outer surface of the glass plate.

The light emitting unit 6 is disposed in the inner space 53 and is adapted to emit an initial light. More specifically, the light emitting unit 6 is disposed on the bottom plate 52. The light emitting unit 6 includes a plurality of light emitting members 61, such as light emitting diodes (LEDs), each of which is disposed on the bottom plate 52. In the embodiment, the light emitting members 61 are blue LEDS such that the initial light is a blue light. Alternatively, the light emitting unit 6 may be in coordination with the photoluminescent unit 7 to emit the initial light of other light colors. In another form, the light emitting members 61 may not be disposed on the bottom plate 52 and the initial light may be reflected by the bottom plate 52. It is noted that when the recognition apparatus 3 is integrated into a thin film transistor liquid crystal display (TFTLCD), the light emitting unit 6 may be configured to be a backlight module.

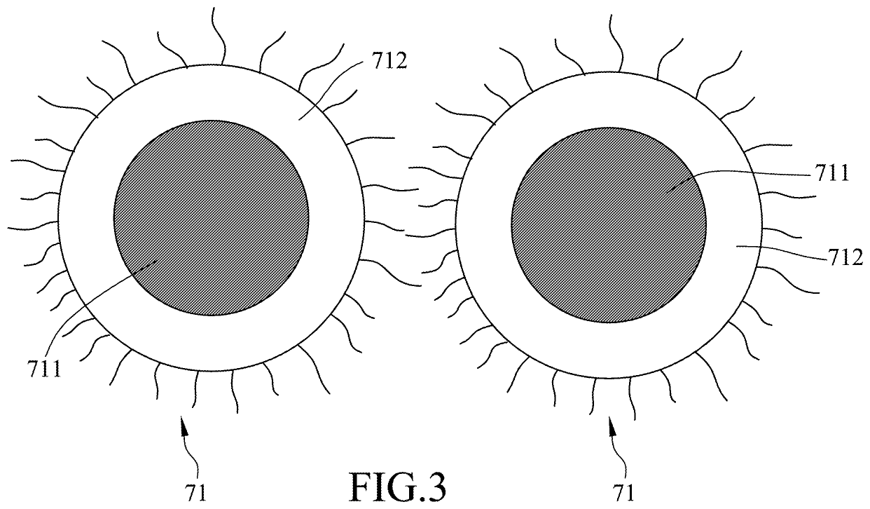

The photoluminescent unit 7 is disposed in the inner space 53. The photoluminescent unit 7 includes a plurality of quantum dots 71 that are able to be excited by the initial light to emit an excitation light having a wavelength range different from that of the initial light. The excitation light travels along a first path (P1) to exit from the inner space 53 through the light-transmissible top plate 51 for irradiation on the object 4 and is reflected from the object 4 to generate a reflection light travelling along a second path (P2) to re-enter the inner space 53. The quantum dots 71 of the photoluminescent unit 7 are selected from pervoskite quantum dots and core-shell quantum dots. When the quantum dots 71 are the pervoskite quantum dots, the pervoskite quantum dots may be made from CsPbX₃, wherein X is selected from one of Cl, Br, and I. When the quantum dots 71 are the core-shell quantum dots, as shown in FIG. 3, each of the core-shell quantum dots may have a core 711 made of lead sulfide (PbS) and a shell 712 enclosing the core 711 and made of cadmium sulfide (CdS). In the embodiment, the photoluminescent unit 7 is able to be excited by the initial light of the blue light so as to emit the excitation light that is an infrared light. Each of the first path (P1) and the second path (P2) are shown but is not limited to be perpendicular to a normal direction of the light-transmissible top plate 51.

The sensor module 8 is disposed in the inner space on the second path (P2) so as to receive the reflection light and to recognize an image of the object 4 generated by the reflection light. The sensor module 8 includes an imaging unit 81, a data storage unit 82, and a recognition unit 83.

In the embodiment, the imaging unit 81 is disposed on the second path (P2) and is used for generating the image of the object 4 from the reflection light received by the sensor module 8. Specifically, the imaging unit 81 includes a photosensitive element 811 for generating the image from the infrared light, which is reflected from the object 4 to be recognized, such as the user's fingerprint, and re-enters the inner space 53 to irradiate on the photosensitive element 811. In this embodiment, the photosensitive element 811 is exemplified to be a charge-coupled device (CCD). In one form, the photosensitive element 811 may be a thin-film photodiode or a phototransistor light sensor.

The data storage unit 82 is used for storing reference data 821. In the embodiment, the reference data 821 relates to types and locations of a plurality of featuring points (such as ridge ending points or bifurcations of fingerprint ridges). The featuring points are obtained by processing reference fingerprint images that is created and prestored in the data storage unit 82 using image processing techniques.

The recognition unit 83 is in communication with the imaging unit 81 and the data storage unit 82 to convert the image to recognition data 831 and compares the recognition data 831 with the reference data 821. In the embodiment, the recognition data 831 relates to locations of a plurality of featuring points obtained by processing the user's fingerprint image using image processing techniques. The recognition data 831 is then compared with the reference data 821 that is stored in the data storage unit 82 by the recognition unit 83. When a level of matching between the recognition data 831 and the reference data 821 achieves a predetermined threshold stored in the recognition unit 83, the recognition unit 83 will generate a positive signal representing that the recognition data 831 corresponds with the reference data 821. When the level of matching between the recognition data 831 and the reference data 821 is lower than the predetermined threshold, the recognition unit 83 will generate a negative signal representing that the recognition data 831 does not correspond with the reference data 821, i.e., the user's fingerprint cannot be recognized by the recognition apparatus 3 and the identification of the user should be further inspected.

It is noted that conversion of the images generated by the imaging unit 81 to the recognition data 831 or conversion of the prestored images to the reference data 821 may be conducted by various other image converting or processing methods. Since the image converting or processing methods are not the essence of the present disclosure, they will not be further elaborated for the sake of brevity.

When the embodiment of the recognition apparatus 3 is operated to recognize the user's fingerprint, the user first presses the light-transmissible plate 51 with a finger, the initial blue light emitted from the light emitting unit 6 first excites the photoluminescent unit 7 to generate the excitation infrared light, and then the excitation infrared light irradiates the user's finger and is reflected from the user's finger to generate the reflection infrared light. Thereafter, the reflection infrared light irradiates the photosensitive element 811 of the imaging unit 81 to generate the user's fingerprint image, and the fingerprint recognition is then carried out by the recognition unit 83 by comparing the recognition data 831 based on the user's fingerprint image with the reference data 821.

In the embodiment, since the excitation infrared light will not be interfered by a visible light used in the touch panel 51, the photoluminescent unit 7 and the sensor module 8 may be directly disposed under the light-transmissible plate 51. Hence, the problem of light interference encountered by the conventional optical recognition apparatus 1 can be eliminated. More specifically, in this embodiment, the light-transmissible top plate 51 is configured to be a touch panel 51 pressable by the human being, and the sensor module 8 is configured to be a fingerprint recognition module 8. The photoluminescent unit 7 and the sensor module 8 are disposed between the touch panel 51 and the light emitting unit 6. The photoluminescent unit 7 has a photoluminescent layer 70 underlying the touch panel 51. The sensor module 8 is disposed on the photoluminescent unit 7. More specifically, the sensor module 8 is disposed between the photoluminescent layer 70 and the touch panel 51, and the photoluminescent layer 70 entirely covers a normal projection of the touch panel 51 onto the photoluminescent layer 70. Hence, the whole first surface 511 of the touch panel 51 to be pressed by the user can have the recognition function. More specifically, the touch panel 51 has a fingerprint area 510 that is aligned with the sensor module 8 along a direction perpendicular to the touch panel 51. In addition, when the recognition apparatus 3 is integrated into the electronic equipment that has a backlight module (not shown), the light emitting unit 6 can be replaced with the backlight module. Since the photoluminescent layer 70 is a thin film, the electronic equipment provided with the backlight module and the recognition apparatus 3 can be maintained as a thin structure.

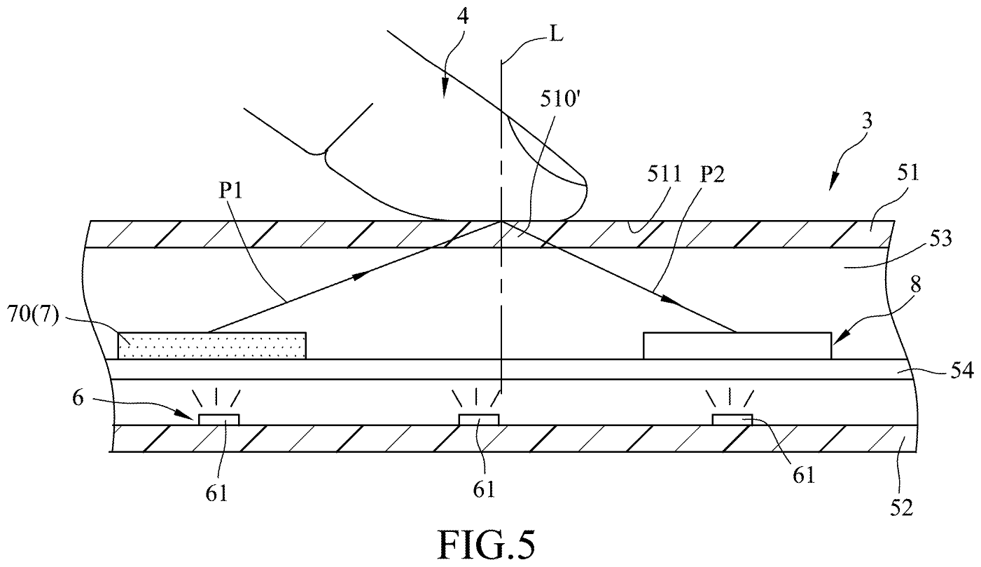

Referring to FIG. 5, another form of the embodiment of the recognition apparatus 3 according to the disclosure is illustrated. The recognition apparatus 3 may further include a mid-layer structure 54 that is disposed between the light-transmissible top plate 51 and the bottom plate 52. The sensor module 8 and the photoluminescent layer 70 are formed on the mid-layer structure 54 and are spaced apart from each other. When the electronic equipment to be integrated with the recognition apparatus 3 of the disclosure is an LCD apparatus, the mid-layer structure 54 may be configured to be a polarizer, a glass sheet on which a plurality of thin film transistors are formed, or a color filter. More specifically, the sensor module 8 is disposed at a location that is distant from the photoluminescent layer 70 along a direction transverse to a normal direction perpendicular to the touch panel 51. In other words, the first path (P1) and the second path (P2) respectively cooperate with the first surface 511 of the light-transmissible top plate 51 to form an acute included angle. The touch panel 51 has a fingerprint area 510 that is out of alignment with either one of the sensor module 8 and the photoluminescent layer 70 along a normal direction perpendicular to the touch panel 51, and a normal line (L) that extends perpendicularly through the fingerprint area 510′ and is situated between the sensor module and the photoluminescent layer 70. Therefore, the areas of the photoluminescent unit 7 and the sensor module 8 can be reduced and the manufacturing cost of the recognition apparatus 3 can be reduced, accordingly.

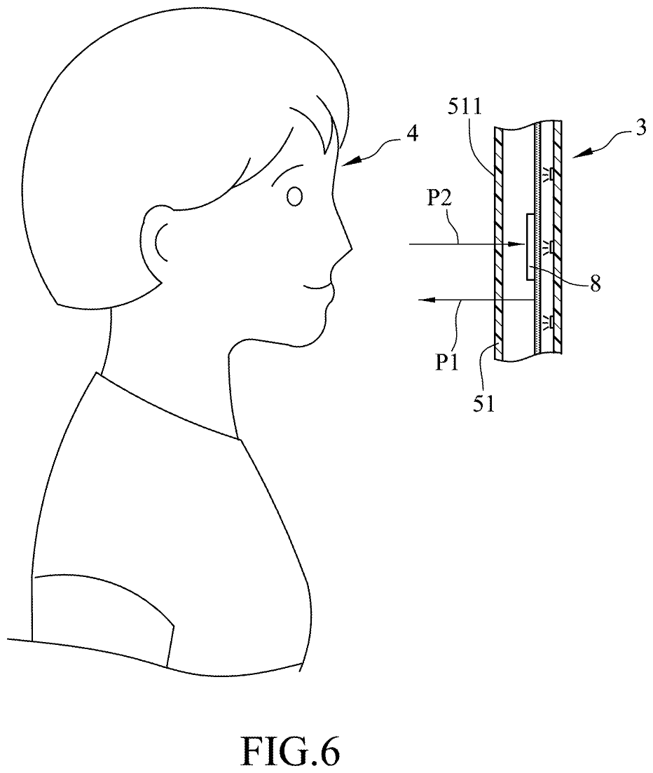

Referring to FIGS. 4 and 6, in still another form of the embodiment of the recognition apparatus 3 according to the disclosure, the sensor module 8 is configured to be a face recognition module. The reference data 821 prestored in the data storage unit 82 is converted from human beings' face image. When the recognition apparatus 3 is in operation, the initial light emitted from the light emitting unit 6 excites the photoluminescent unit 7 to generate the excitation light. Then, the excitation light travels along the first path (P1) for irradiation on the user's face and is reflected from the user's face to generate a reflection light that travels along the second path (P2) to re-enter the inner space 53. Thereafter, the reflection light is received by the imaging unit 81 of the sensor module 8 for generating the image, and the recognition unit 83 converts the image of the user's face to the recognition data that includes locations of a plurality of featuring points of the user's face. Finally, the recognition data 831 is compared with the reference data 821 by the recognition unit 83 for recognition function.

To sum up, by virtue the inclusion of the photoluminescent unit 7, the excitation light emitted therefrom is the infrared light, which is not interfered by other visible light present in the recognition apparatus 3 or the electronic equipment integrated therewith. Thus, the recognition quality is enhanced. Furthermore, the structural design of the photoluminescent layer 70 facilitates maintenance of the thin structure of the electronic equipment that is provided with the backlight module and the recognition apparatus 3 of this disclosure.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A recognition apparatus, comprising:
a light-transmissible top plate, having a first surface facing an object to be recognized and a second surface opposite to said first surface;
a bottom plate spaced apart from said light-transmissible top plate and facing said second surface of said light-transmissible top plate, said light-transmissible top plate and said bottom plate cooperatively defining an inner space therebetween;
a light emitting unit disposed in said inner space and adapted to emit an initial light;
a photoluminescent unit disposed in said inner space, said photoluminescent unit including a plurality of quantum dots that are able to be excited by the initial light to emit an excitation light having a wavelength range different from that of the initial light, the excitation light travelling along a first path to exit from said inner space through said light-transmissible top plate for irradiation on the object and being reflected from the object to generate a reflection light travelling along a second path to re-enter said inner space; and
a sensor module disposed in said inner space on the second path so as to receive the reflection light and to recognize an image of the object generated by the reflection light.

2. The recognition apparatus of claim 1, wherein said sensor module includes an imaging unit for generating the image from the reflection light received by said sensor module, a data storage unit for storing reference data, and a recognition unit being in communication with said imaging unit and said data storage unit to convert the image to recognition data and comparing the recognition data with the reference data.

3. The recognition apparatus of claim 2, wherein the excitation light is an infrared light, said imaging unit of said sensor module including a photosensitive element for generating the image from the infrared light received by said sensor module.

4. The recognition apparatus of claim 3, wherein the initial light is a blue light.

5. The recognition apparatus of claim 1, wherein said quantum dots are selected from pervoskite quantum dots and core-shell quantum dots.

6. The recognition apparatus of claim 5, wherein said quantum dots are core-shell quantum dots, each of said core-shell quantum dots having a core made of lead sulfide (PbS) and a shell enclosing said core and made of cadmium sulfide (CdS).

7. The recognition apparatus of claim 2, wherein said sensor module is configured to be a face recognition module, said reference data stored in the data storage unit being converted from human beings' face images.

8. The recognition apparatus of claim 1, wherein said light-transmissible top plate is configured to be a touch panel pressable by a human being, said sensor module being configured to be a fingerprint recognition module.

9. The recognition apparatus of claim 1, wherein said light emitting unit is disposed on said bottom plate.

10. The recognition apparatus of claim 9, wherein said sensor module is disposed on said photoluminescent unit.

11. The recognition apparatus of claim 9, wherein said light-transmissible top plate is configured to be a touch panel, said photoluminescent unit and said sensor module being disposed between said touch panel and said light emitting unit, said photoluminescent unit having a photoluminescent layer underlying said touch panel.

12. The recognition apparatus of claim 11, wherein said sensor module is disposed between said photoluminescent layer and said touch panel, and said photoluminescent layer entirely covers a normal projection of said touch panel onto said photoluminescent layer.

13. The recognition apparatus of claim 12, wherein said touch panel has a fingerprint area aligned with said sensor module along a direction perpendicular to said touch panel.

14. The recognition apparatus of claim 11, wherein said sensor module is disposed at a location that is distant from said photoluminescent layer along a direction transverse to a normal direction perpendicular to said touch panel.

15. The recognition apparatus of claim 14, wherein said touch panel has a fingerprint area that is out of alignment with either one of said sensor module and said photoluminescent layer along the normal direction perpendicular to said touch panel, a normal line that extends perpendicularly through said fingerprint area being situated between said sensor module and said photoluminesent layer.

16. The recognition apparatus of claim 15, further comprising a mid-layer structure disposed between said light-transmissible top plate and said bottom plate, said sensor module and said photoluminescent layer being formed on said mid-layer structure.
